(19) United States
(12) Patent Application Publication
(10) Pub. No.: US 2012/0077556 A1
(43) Pub. Date: Mar. 29, 2012

(54) Integrated Protective Case with Stand and Attached Extendable Earbud Piece Assembly for Portable Electronic Devices

(76) Inventor: Donovan Miguel McKendrick, San Francisco, CA (US)

(21) Appl. No.: 13/247,970

(22) Filed: Sep. 28, 2011

Related U.S. Application Data
(60) Provisional application No. 61/387,691, filed on Sep. 29, 2010.

(51) Int. Cl. H04W 88/02; H04R 1/02

(52) U.S. Cl. 455/575.8; 381/333

(57) ABSTRACT

The present invention relates to protective cases for portable electronic devices that include an extendable and retractable earbuds and speaker assembly accompanied by an integrated support structure so that the portable electronic device can sit upright and be used to listen and speak through. In particular, embodiments of the present invention include a protective frame with an integrated upright support structure that pulls out from the back surface of the protective case. Embodiments further include extendable and retractable earbuds, with an earbud cord spool that has a spring-loaded retractor mechanism, allowing for the earbuds and cord to be extended out and locked in place once pulled out to the appropriate length and retracted upon cessation of use. Embodiments of the present invention may be used with any type of portable electronic device including portable media players and portable cellular telephones. It may be particularly useful with portable electronic devices that use a touchscreen input and may utilize software that facilitates virtual face-to-face communications.

### CROSS-REFERENCE TO RELATED APPLICATIONS

This application claims the benefit of U.S. Provisional Application No. 61/387,691 filed on Sep. 29, 2010, the entirety of which is incorporated herein by reference.

### BACKGROUND OF TUE INVENTION

The present invention relates to protective frames for portable electronic devices that can be used to support the device in an upright position and provide an extendable and retractable earbuds and speaker assembly for the user.

Protective cases for personal electronic devices are known. Personal electronic communications devices, due to their size, and the fact that consumers carry them, are subject to wear and tear and damage, including the cracking of the glass upon the device and other components. To avoid this, the prior art has developed protective cases in which the portable electronic device is housed when carried by the consumer.

The present invention relates to portable electronic devices such as cellular phones, iPhone™ communication devices, personal digital assistant devices and the like. More particularly, it relates to carrying cases for such devices, which have enhanced capabilities beyond the protective properties.

There is a significant problem with such portable electronic devices such that when the earbuds and speaker assembly is not being used, it must be stored separately or often wrapped around the portable electronic device in such a manner that it becomes tangled, becoming a nuisance for the user to reconnect the earbud and speaker assembly and to untangle the earbuds and speaker assembly.

Another problem occurs when trying to view the screen, particularly when using devices with software programs that allow virtual face-to-face communications among users, a recent development within the field of portable electronic devices that enables two-way communication. Changes in the statutory framework around operating a motor vehicle and communicating through a personal electronic device further necessitate the need to have an integrated earbuds and speaker assembly within the protective case for the portable electronic device.

Thus, a need exists for improvements in the design of these cases simultaneous to their use for communication, particularly where it is necessary to use the device for face-to-face virtual communications. The integration of upright support coupled with the earbud and speaker assembly enables portable electronic devices to be used in such a way to fully support seamless virtual face-to-face communications.

### SUMMARY OF THE INVENTION

The present invention involves carrying cases for portable electronic devices with integrated upright support for the portable electronic device and an extendable and retractable earbuds and speaker assembly.

In the preferred embodiment, an integrated upright support structure that allows the invention to sit upright pulls out from the back of the protective case at an angle. This hinged component folds into the exterior of the protective case assembly when the integrated upright support structure is not in use. When extended, the integrated support structure allows the device to sit upright.

In the preferred embodiment, the earbud and speaker assembly is a compact component housed in a molding on the back of the protective case, containing a spring-loaded retractor mechanism, which allows the user to retract the earbud and speaker assembly into the phone. The audio jack connection connects to this spool through an internal wire within the protective case. When pulled from the retractable spool, the earbuds can be used without becoming entangled.

In the preferred embodiment, spaces are fashioned into the protective case to allow for access to the necessary external operating buttons of the portable electronic device, including, but not limited to, power control mechanisms and sound control mechanisms.

In another embodiment of the present invention, the speaker transducer sits on the back of one of the earbuds.

in yet another embodiment of the present invention, the back of the case will separate from the top of the case, allowing the portable electronic device to slide into the protective case and connect to the audio jack, which will align with the portable electronic devices' audio port.

### BRIEF DESCRIPTION OF THE DRAWINGS

The invention may take form in various components and arrangements of components, and in various steps and arrangements of steps. The drawings are only for purposes of illustrating a preferred embodiment(s), and are not to be construed as limiting the invention.

FIG. 1 is the back view of one embodiment of the present invention, which contains an integrated support structure that is moveable, attached by a hinge and extendable from the protective case to provide upright support and recessed back into the case when upright support use is ceased;

FIG. 2 is the front view of one embodiment of the present invention;

FIG. 3 is a view of the top of one embodiment of the present invention, displaying the positioning of the earbud and speaker assembly upon the protective case;

FIG. 4 is a perspective side view of one embodiment of the present invention, wherein the several openings are shown to demonstrate the intent for access to the necessary external operating buttons of a portable electronic device;

FIG. 5 is the earbud and speaker spool assembly of one embodiment of the present invention, shown therein in the retracted position;

FIG. 6 is a frontal view of the spool's detachable external mold casing of one embodiment of the present invention, wherein the spool assembly will be housed; and

FIG. 7 is a perspective side view of one embodiment of the present invention, where the upright support arm is shown in its extended position.

### DETAILED DESCRIPTION OF THE INVENTION

The present invention relates to carrying cases for portable electronic communications devices with integrated upright support for the portable electronic device and a retractable and extendable earbuds and speaker assembly.

One aspect of the present invention is that it provides advantages and improved characteristics over the prior art, e.g., it is multi-functional and more compact. This integrated case addresses the inconvenience of dealing with carrying a portable electronic device within the protective case and the earbuds and speaker assembly products separately.

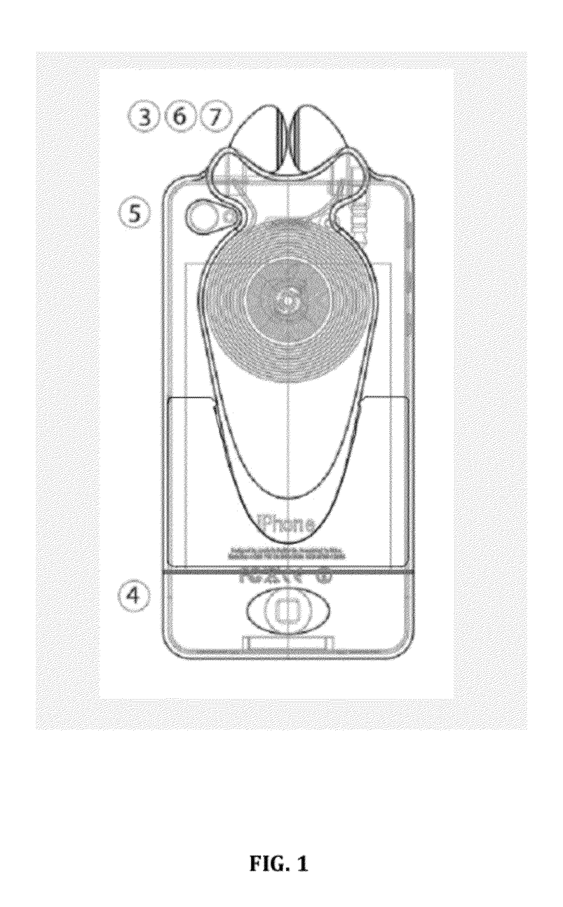

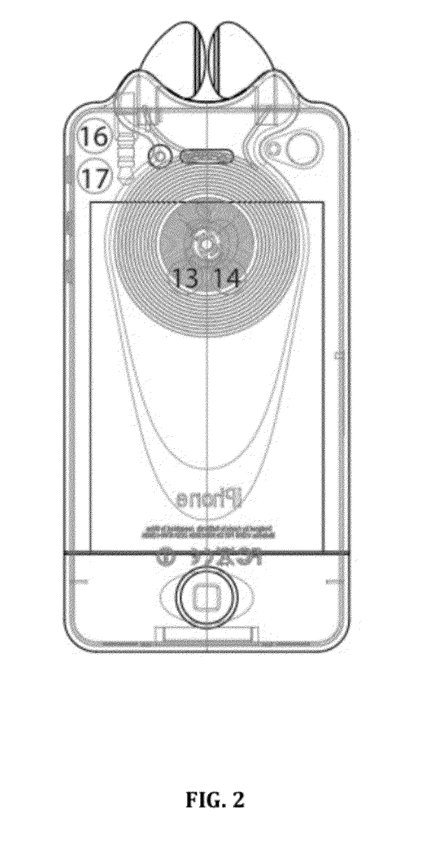

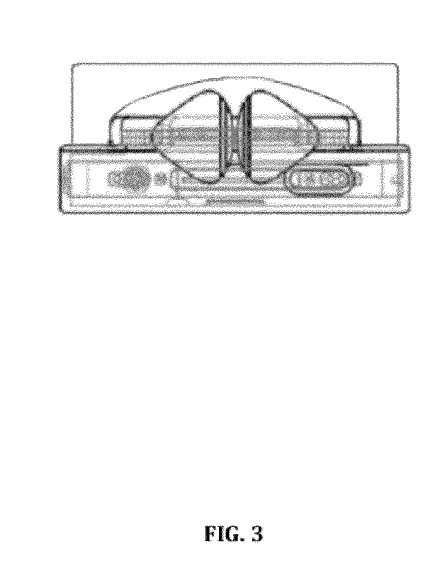

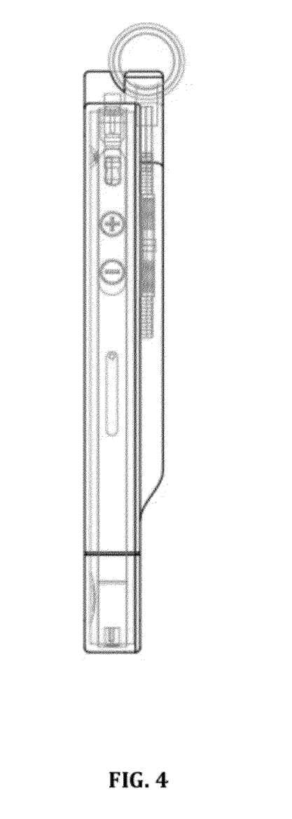

Referring now to FIGS. 1 to 4, the protective frame is designed to enclose and protect portable electronic devices. As illustrated by FIGS. 1 to 4, the frame generally includes front and back components that affix together, in a rectangular or similar shape, with a perimeter constituting four sides.

In the manufacturing of the present invention, the integrated frame and stand with attached retractable earbuds may be configured to allow for different portable electronic devices with different connections, buttons, port locations and sizes to be accommodated. These connections, buttons and port locations may be located on the front, back or perimeter of the frame.

In one embodiment, the frame can be enclosed upon the portable electronic device with the front and back components joined along the perimeter of the case in a fashion that allows it to open in the same manner as a clamshell.

In another embodiment, the case may include a top and bottom component that slide into one another.

The composition of the frame of the present invention borrows from molding techniques used to form various shapes of the frame that are used and known by those skilled in the art. The protective case may be subject to various configurations and may have different dimensions depending on the portable electronic device that it may house. The embodiments will differ on a device-by-device basis and nothing in the drawing should be construed as limiting the protective case frames use to a particular device, whether now in existence or devices not yet contemplated or on the market.

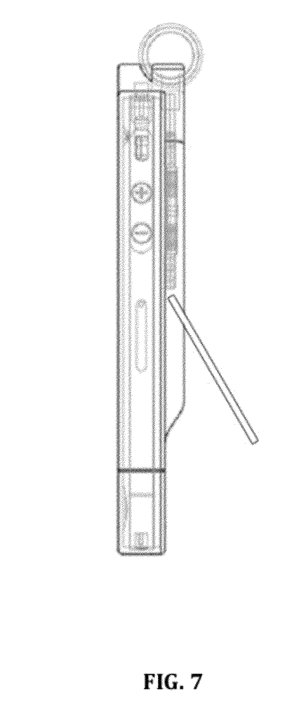

Referring now to FIG. 7, the present invention includes a hinged integrated upright support that folds into the back component of the protective case. This integrated upright support may or may not be connected to the protective case in the same position displayed in FIG. 7 in various embodiments of the protective case. This hinged integrated upright support may have to be configured and sized to accommodate the various sizes and presentations of the particular portable electronic device that it may house.

In one embodiment, this integrated upright support arm may take on a “V” shape, whereby the user pulls the integrated upright support component out of the back of the protective case, allowing the arm to arrive at a “V” shape angled approximately 60 degrees or less from the back of the protective case. This hinged integrated support allows the device to sit upright on a planar surface, such as a counter, desk or other related surface with planar properties. The angle of the hinged integrated upright support may vary.

In another embodiment, the integrated upright support may be hinged in a manner that makes it one molded piece where the hinge can be pulled out to support the device in the upright position.

A multiplicity of hinge types may be used in various embodiments of the present invention. An alternative to a hinge may also be used in various embodiments of the present invention, as referred to in FIG. 7.

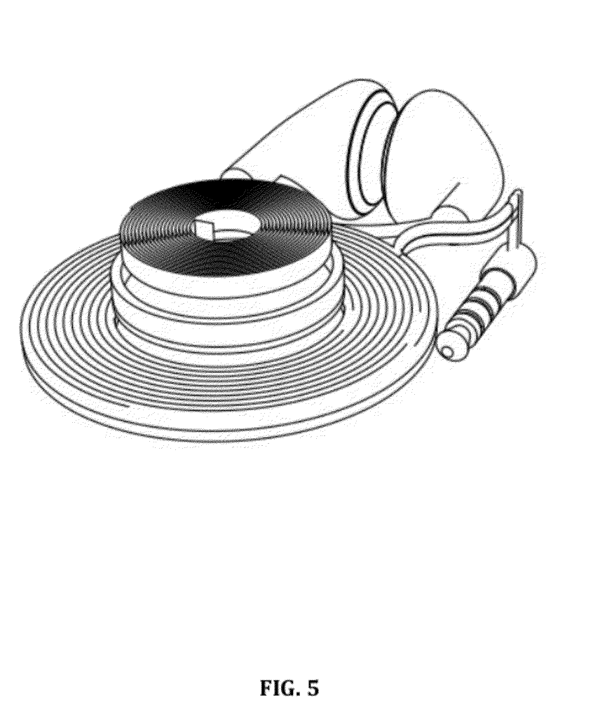

Referring now to FIG. 5, the earpiece assembly consists of earbuds, a speaker and cord. The cord and earbud and speaker assembly are wrapped around a spring-loaded spool mechanism, where the cord can be extended and retracted in a fluid motion.

In one embodiment, the earbud and speaker spool assembly contains an audio jack that connects to the earbuds through an internal wire that runs through the spool and directly to the earbuds. The earbud cord spool has a spring-loaded spool mechanism, allowing for the earbud and speaker assembly to be extended to an appropriate length and retracted. The user will pull upon the cord to “unlock” the spring, allowing the earbud and speaker cords to be retracted back around the spool and into the portable electronic device.

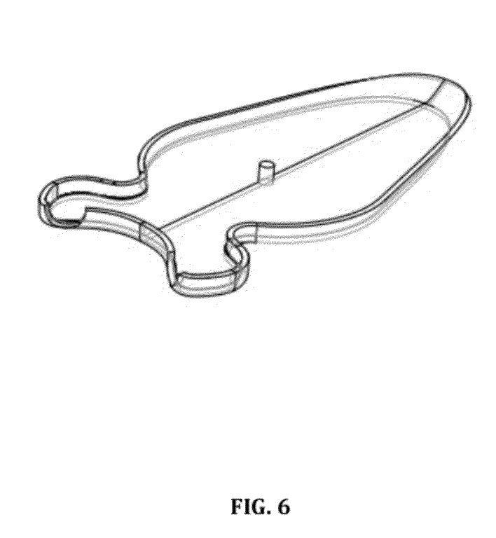

Referring now to FIG. 6, the back of the case includes molded removable housing for the coil assembly. The back component of the case that runs flush with the back of the portable electronic device houses the extension and retraction assembly for the rotatable spool, as referred to by FIG. 5. The removable housing piece includes a raised hub, with the top portion containing a circular component to house the spool. The spool retractor mechanism fits firmly into the back of the case and is covered by the raised molded housing piece.

Referring now to FIG. 5, the earpiece and speaker assembly can include transducers such as an earbud and microphone. The earpiece assembly includes an electrical cord, with an insulated earbud ground wire and insulated microphone wire to couple the ability to transmit and receive voice and audio signals.

In another embodiment, the internal audio wire connects to an axle chamber within the spool that has contact with the outer wheel and connects to the earbuds, completing the connection between the earbuds and the audio jack.

In yet another embodiment, the internal wire from the audio jack connects to an axle, which connects to the earbud wires, and then runs through an outer wheel that contains the wires once they are retracted.

In yet another embodiment, the spool housing may be removed to expose the spool, allowing for the spool and attached earbud and speaker assembly to be replaced with different versions, allowing for interchangeability of the earbud and speaker assembly.

The invention has been described with reference to the preferred embodiment(s). The modifications and alterations may occur upon reading and understanding the preceding detailed description. It is intended that the invention be construed as including all such modifications and alterations insofar as they come within the scope of the appended claims or the equivalents thereof.

What is claimed:

1. A protective case for a portable electronic device, the protective case comprising:
a housing that has a front, back and side perimeter;
a housing adapted with a support arm attached to the protective case that can be extended and recessed upon which the phone can sit upright on a planar surface; and
a housing adapted with an earpiece assembly including a tiny speaker on the back of one earbud that facilitates communication through the earbud assembly, the earpiece assembly being extendable and retractable relative to the housing.

2. The protective case of claim 1, which is comprised of:
a front portion;
a back portion; and
two side portions forming the perimeter of the protective case.

3. The protective case of claim 1, wherein
the earpiece assembly contains an earbud and microphone.

4. The earpiece assembly of claim 3, wherein
the earpiece assembly includes at least two transducers from the group consisting of an earbud and a microphone speaker; and
the cord includes a wire that combines a microphone wire and earbud wire into one protected electrical cord.

5. The protective case of claim 1, wherein
a spool is contained with a spring-loaded retractor mechanism for an earpiece assembly and cord;

6. The spool of claim 5, wherein
the spool enables an extension and retraction assembly, allowing for the earpiece assembly to be extended and locked into position once at the appropriate length, and retracted to the spool once use has ceased.

7. The protective case of claim 1, wherein
the housing includes an external raised storage cavity for the spool referenced in claim 5.

8. The external raised storage cavity of claim 7, wherein
the external raised storage cavity is affixed to back of the protective case referenced in claim 1 in a manner where is it removable.

9. The protective case of claim 1, with housing comprising:
a frame; and
a support arm, wherein the support arm is attached to the protective case referenced in claim 1.

10. The support arm of claim 9, wherein the support arm is connected to the protective case with a hinge, from a group comprised of spring-loaded hinges, butt hinges, butterfly hinges, flush hinges, barrel hinges, concealed hinges, continuous hinges, ball bearing hinges, double-acting hinges, knuckle hinges, blind hinges, “V” shaped hinges and pivot hinges.

11. An apparatus, which is comprised of:
a frame;
a support arm; and
an earbud and microphone earpiece assembly.

12. The support arm of claim 11, wherein
the support arm is attached to the frame referenced in claim 11.

13. The earbud and microphone earpiece assembly referenced in claim 11, wherein
the earpiece assembly includes at least two transducers from the group consisting of an earbud and a microphone speaker; and
the cord includes a wire that combines a microphone wire and earbud wire into one protected electrical cord.
